(19) United States
(12) Patent Application Publication
(10) Pub. No.: US 2009/0193644 A1
(43) Pub. Date: Aug. 6, 2009

(54) Double nut bolted connection with cheese plate for reinforcing existing riveted or bolted structures under load

(76) Inventor: Michael James Malloy, Avon, OH (US)

Correspondence Address: Michael James Malloy, 35280 Saddle Creek Drive, Avon, OH, 44011, US

(21) Appl. No.: 12/321,396

(22) Filed: Jan. 21, 2009

Related U.S. Application Data
(60) Provisional application No. 61/062,994, filed on Jan. 31, 2008.

(51) Int. Cl. B23P 11/00

(52) U.S. Cl. 29/525.02

(57) ABSTRACT

This invention is a method for connecting new material to existing connections for purposes of strengthening, without removing the existing load, and generally applies to bridges and buildings made of steel with bolted or riveted connections. It uses special order high strength bolts with enough thread for two nuts a cheese plate and new material to be attached to the existing connection. The cheese plate is a thick fill plate with larger diameter holes than a washer and nut. The method removes as little as one rivet or bolt at a time, and replaces it with the special order high strength bolt and only one nut. After all the fasteners are replaced, the cheese plate and new material are installed and a second nut is added to complete the attachment of the new material. Previously, structures like this would have to be temporarily supported to disassemble and attach new material.

### CROSS-REFERENCE TO RELATED APPLICATIONS

This application claims priority to the provisional application 61/062,994 filed on Jan. 31, 2008.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention generally applies to bridges, buildings, and other heavy civil engineering structures generally made of steel with riveted or bolted connections and/or riveted built-up members and splice plates that need strengthening under load. This invention is a method for connecting new material to be added to existing connections for strengthening purposes without removing the existing load.

Previously, in large civil structures with bolted or riveted connections, if a structural element was found to be weak, or needed strengthening to accommodate a new loading condition, the existing structural material would have to be temporarily supported and/or the load would have to be temporarily removed from the structure so that the old material could be disassembled, replaced or strengthened. In non-redundant or limited redundant structures, this often requires extensive analysis and monitoring of existing members with strain gauges during the repair procedure. Often temporarily supporting members is difficult because of the location of the connections and the high loads required to be supported. In addition, reducing loads on these structure is not always feasible on heavily utilized structures, such as bridges, that cannot be closed without a significant disruption to traffic.

Standard high strength bolts which are typically used in the connections for these types of structure, are ASTM A490 and A325 bolts. These bolts have standard thread lengths of 2 times the diameter plus ¼ inch. This does not allow for two nuts with additional material to be placed on one bolt.

The closest prior art to this invention is the process of adding multiple smaller plates, one at a time, which requires removing multiple rivets or bolts at a time. The disadvantage of this method, is the final plate is not a single unit, and more than one rivet or bolt must be removed at one time, thus increasing the stress on the connection during installation, and typically requiring some type of temporary support.

### BRIEF SUMMARY OF THE INVENTION

This invention is a method for attaching new structural material to existing connections under load in order to strengthen an existing structure. It utilizes special order ASTM A490 or A325 bolt, properly designated as ASTM A354. These special order bolts are ordered with extra long threads to allow for two nuts and washers, a cheese plate at least the thickness of one nut, and the new strengthening material.

The method allows for the removal of as little as one rivet or bolt at a time and replaces it with the special order extra long threaded bolt and one nut. This one nut is fully tightened, then the next rivet or bolt is removed and replaced with another special order extra long threaded bolt and one nut. This procedure is repeated until each rivet or bolt is replaced. This allows the connection to continue carrying load since only one rivet or bolt is removed at a time while the others remain intact. Once all the rivets or bolts are replaced, a cheese plate, a plate washer slightly thicker than a nut with large diameter holes centered over each nut, is placed over the threaded side of the bolts. Each large diameter hole in the cheese plate is large enough to allow for a nut to fit inside. Then the new structural material required for strengthening is attached. The new material has standard size bolt holes, and is placed over the bolts and a second nut is added to each bolt and is fully tensioned.

### BRIEF DESCRIPTION OF THE SEVERAL VIEWS OF THE DRAWING

FIG. 1 is the plan view of a typical deteriorated splice plate connection. FIG. 2 is the cross section of FIG. 1.

FIG. 3 is the plan view of the deteriorated splice plate connection with one special order bolt installed with one nut, and one rivet removed.

FIG. 4 is the cross section of FIG. 3.

FIG. 5 is the plan view of the deteriorated splice plate connection with all the special order bolt installed with one nut each.

FIG. 6 is the cross section of FIG. 5

FIG. 7 is the plan view of the deteriorated splice plate connection with the cheese plate installed over the special order bolts and first nuts.

FIG. 8 is the cross section of FIG. 7

FIG. 9 is the plan view of the deteriorated splice plate connection with new strengthening material with standard size holes installed over the special order bolts and first nuts. It also shows four second nuts installed over the strengthening plate.

FIG. 10 is the cross section of FIG. 9

FIG. 11 is the plan view of the completely repaired deteriorated splice plate connection with the new strengthening material attached per the invented method with all the second nuts installed.

FIG. 12 is the cross section of FIG. 11

FIG. 13 is a comparison view showing the differences between rivets, standard bolts, and the special order bolts used in this attachment method.

### DETAILED DESCRIPTION OF THE INVENTION

This invention is a method for attaching new structural material in order to strengthen existing riveted or bolted structural members in place and under load, meaning that the connection continues to carry load and does not need to be temporarily supported nor have load removed during the attachment procedure.

The attachment method replaces rivets and/or bolts at a connection with new, special order, extra long threaded high strength bolts currently designated as ASTM A354. Each bolt has enough thread to accommodated two nuts and two washers, a cheese plate/s, which is a plate washer slightly thicker than the first nut and a washer, any fill plates, and any new material required for strengthening.

Each rivet or bolt in the connection is removed and replaced one at a time. Once one rivet is removed, it is replaced with the special order bolt, with one nut and one washer and fully tensioned prior to the next rivet being removed. Since as little as one rivet or bolt is removed at a time, the reduction in load carrying capacity of the connection is as little as 1 divided by the existing number of fasteners on one side of the connection. Provided there is more than one fastener per side of the connection, the remaining fasteners can carry load. Each new special order bolt is installed so that the threads are on the same side as the new material to be attached.

Once all the rivets or bolts in the connection are removed and replaced with the new bolts, a cheese plate/s is installed over the threaded sides of the bolts. The cheese plate/s is plate washers slightly thicker than the first nut and the first washer, with oversized holes slightly larger in diameter than the washers with each hole centered over each new bolt. The cheese plate/s can be split into multiple plates, or combined into one plate.

Once the cheese plate/s are installed, new structural material is connected to the extra length of the special order bolts protruding through the cheese plates. The new material, with standard size bolt holes, is placed over the bolts and a second nut and washer is added to each bolt and fully tensioned. The new material can be an structural shape, such as a gusset plate, splice plate, beam, chord, web, angle, or flange.

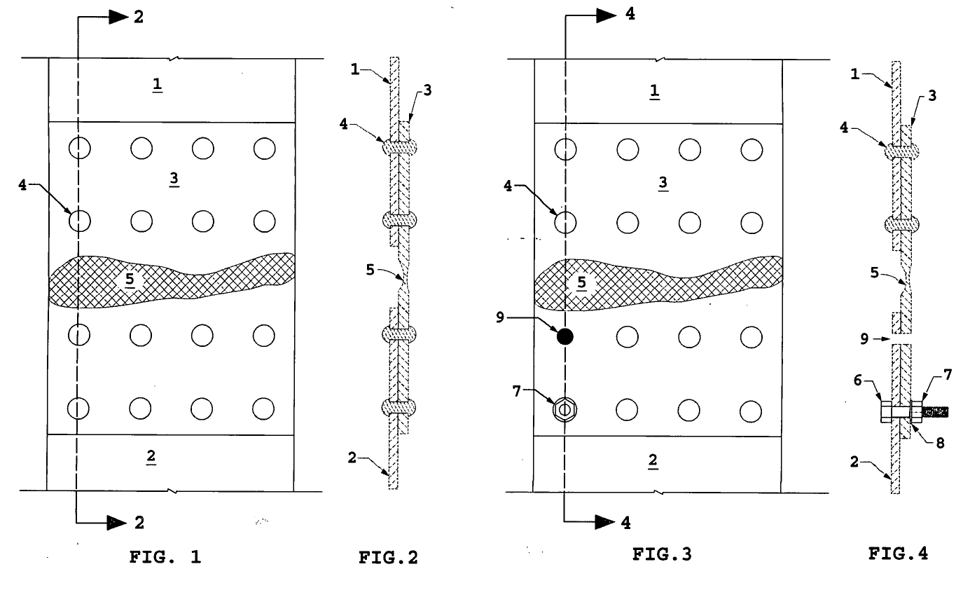

The detail drawings show the step by step attachment method for a typical deteriorated splice plate. Starting at FIG. 1 and FIG. 2 and proceeding to FIG. 11 and FIG. 12. The detail drawings are of a typical repair, and the number of new special order bolts and the shape and size of the connection plates will vary depending what new material is required for strengthening, and what the geometry and fastener pattern of the existing connection is.

FIG. 1 shows the plan view of an existing typical deteriorated splice plate connection. The deteriorated splice plate (3) connects two existing plates (1,2). The upper plate (1) is attached by rivets (4) to the deteriorated splice plate (3) which is connected to the lower plate (2) by rivets (4). The crosshatching area (5) shows the deterioration in the splice plate. FIG. 2 shows the cross-sectional view of FIG. 1.

FIG. 3 is the plan view of the first step of the attachment method with one rivet (4) removed and only showing a hole (9) while one rivet (4) has already been replaced with the special order extra long thread high strength bolt (6) the first nut (7) and washer (8). FIG. 4 is the cross-sectional view of FIG. 3. Note that only one rivet is removed at a time.

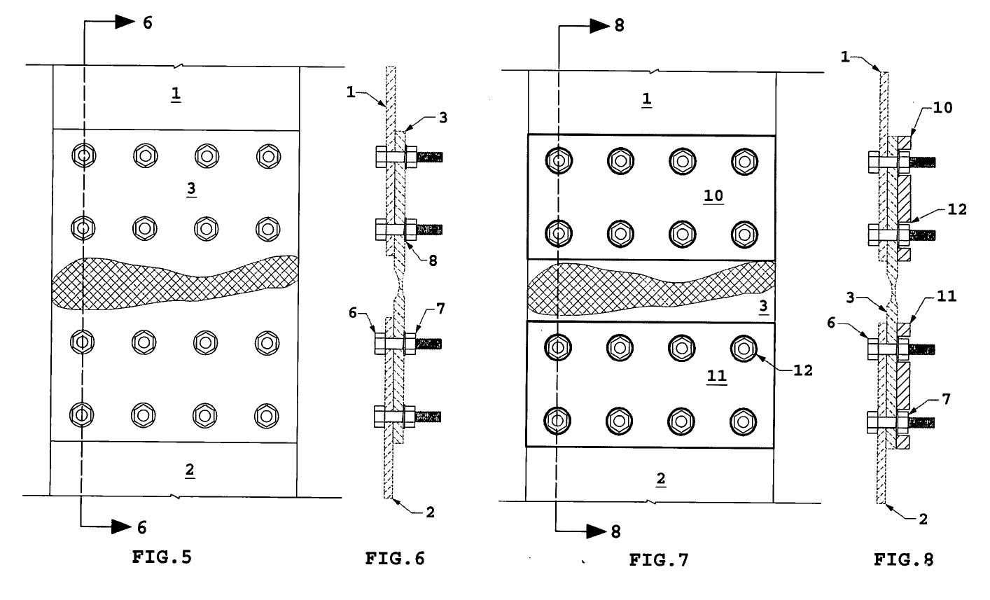

FIG. 5 is the plan view of the deteriorated splice plate (3) with all the rivets (4) replace with the special order bolts (6) the first nuts (7) and one washer (8). FIG. 6 is the cross-sectional view of FIG. 5. Note that all the special order bolts (6) are installed with only one nut (7) each prior to any new material being added.

FIG. 7 is the plan view the deteriorated splice plate (3) with an upper cheese plate (10) and a lower cheese plates (11). Both cheese plates (10,11) have oversized holes (12) with a diameter slightly larger than the washers (8). The cheese plates (10,11) are installed over the special order bolts (6) and first nuts (7). FIG. 8 is a cross-sectional view of FIG. 7. Note the thickness of the cheese plates (10,11) are slightly thicker than the first nut (7) and a washer (8).

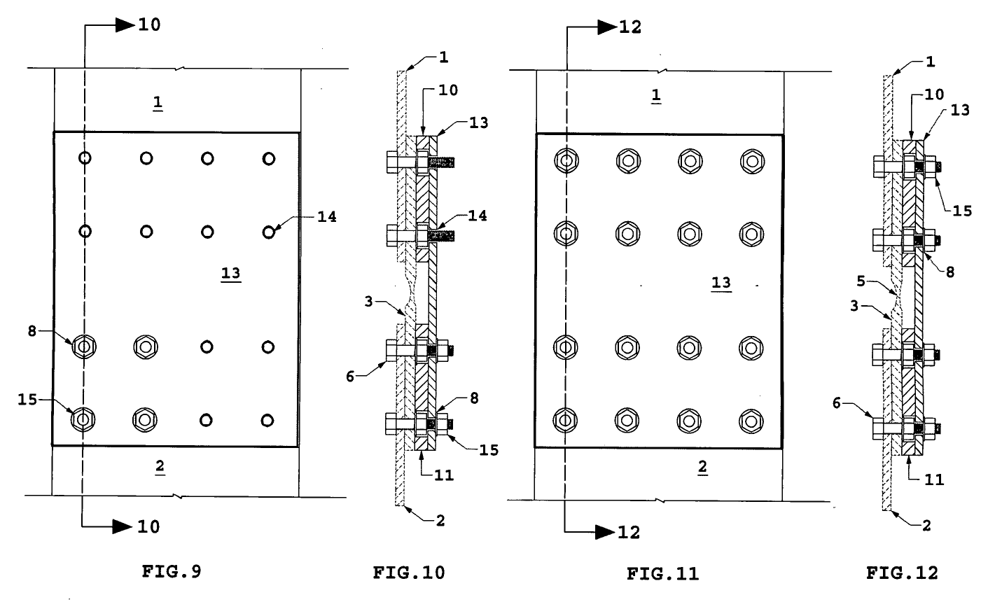

FIG. 9 shows the plan view of the new splice plate (13) placed over the deteriorated splice plate (3) and cheese plates (10,11). The new splice plate has standard size holes (14) centered over each special order bolt (6). FIG. 9 also shows four of sixteen special order bolts (6) with the second nut (15) and second washer (8) installed.. FIG. 10 shows the cross-sectional view of FIG. 9 which shows in detail how the new splice plate (13) is installed over the cheese plates (10,11) and the first nuts (7). FIG. 11 is the plan view of the completed repair, with the new splice plate (13) attached and all the second nuts (15) installed on the special order bolts (6). FIG. 12 is the cross-sectional view of FIG. 11.

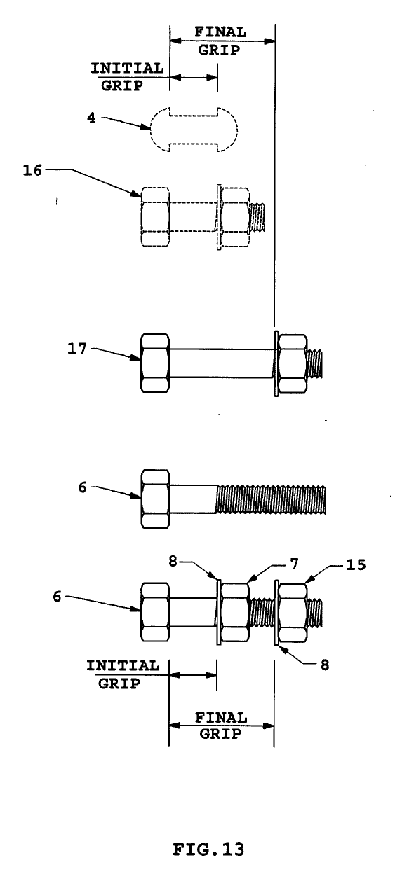

FIG. 13 is a comparison view showing the differences between the existing rivets (4), standard bolts (16,17), and the special order bolt (6) used in this attachment method. FIG. 13 is arranged from top to bottom with a rivet (4) on top then below a short standard high strength bolt (16). Then a long standard high strength bolt (17), then the special order high strength bolt (6) without the nuts for clarity, then at the bottom, the special order high strength bolt (6) with the first nut (7), second nut (15) and the two washers (8). Note that the existing rivet (4) and/or existing bolt (16) have the initial grip required to connect the deteriorated splice plate (3) to the existing plates (1,2), and the standard replacement bolt (17) only has enough thread length to connect the new splice plate (13) and not enough to engage the existing splice plate (3). This is why standard high strength bolts (16,17) will not work in this attachment method. The special order bolt (6) has enough thread to engage both the existing splice plate (3) with the first nut (7) and washer (8), and enough bolt length to engage the new splice plate (13) with the second nut (15) and washer (8).

This attachment method is considered a slip critical connection, so the friction between the plates induced by tensioning the bolts is what holds the connections together.

The inventor recognizes that design changes to the method such as the number of fasteners, changes to the material, changing the positions the washers, adding additional fill plates, providing multiple cheese plates, or, provided the existing joint is adequately strong, removing more than one rivet or bolts at a time, or only replacing a portion of the existing rivets or bolts. It is expected that the following claim will cover such nuances of the attachment procedure.

1. What I claim as my invention is a method for attaching new structural material to existing connections under load in order to strengthen an existing structure, by removing, as little as one existing rivet and/or bolt at a time and replacing it with a special order extra long threaded high strength bolt with enough thread length to allow for two nuts and washers, a cheese plate, new strengthening material to be attached and any fill plates, and installing one nut and fulling tensioning the bolt. Once all the required rivets or bolts to carry the anticipated load are replaced, a cheese plate or plates slightly thicker than the nut and washer with large diameter holes centered over each nut is placed over the threaded side of the bolts. Each large diameter hole in the cheese plate is large enough to allow for a nut and washer to fit inside. Then the new structural material to be attached, with standard size bolt holes, is placed over the bolts and a second nut and washer are added to each bolt and the nut fully tightened to complete the attachment of the new material.
